(19) United States
(12) Patent Application Publication
(10) Pub. No.: US 2013/0011822 A1
(43) Pub. Date: Jan. 10, 2013

(54) Mobile learning system and method

(76) Inventors: Michael Messner, Summit, NJ (US); Robert Schwartz, Princeton, NJ (US); Prasant Varghese, Brooklyn, NY (US)

(21) Appl. No.: 13/135,422

(22) Filed: Jul. 5, 2011

(51) Int. Cl. G09B 25/00

(52) U.S. Cl. 434/365

(57) ABSTRACT

A mobile learning system having (1) a web site which allows a user, typically, a teacher, to gather or import and organize digital educational contents and (2) a software application for use with a tablet, notebook or other portable electronic device associated with a remote user, e.g., a student, which functions to download selected materials from the website. The web site permits a teachers to bundle material for viewing by students on a tablet or notebook device. The web site will allow teachers to locate educational content or upload their own content e.g. e-books, study guides, worksheets and combine them to create units. Units are comparable to chapters of a textbook. These units will be combined to create courses. Through the mobile application, courses containing the individual units will be downloaded to a student's tablet or notebook device. The student will download the application to his device and be able to access the units for his particular course. The teacher will be able to update the course on the web site with new units or changed items and units as time progresses and the software on the mobile device will update or synchronize with the web site so that new or changed items and units are downloaded to the mobile device. The student will download the application, content and updates via a WiFi connection.

### BACKGROUND OF THE INVENTION

The present invention relates generally to a mobile learning system that can be used to deliver educational content to classrooms and learning centers over a wireless network.

The present invention also relates to a remote server having one or more applications that facilitate aggregation and organization of educational content, including video, audio, images and text for delivery to a mobile device.

The present invention also relates to a software application for a mobile device, which when launched permits the mobile device user to wirelessly download education content from the remote server and subsequently view and manipulate it.

Student textbooks are heavy, expensive and outdated. There is a plethora of free, open educational resources (OER) available on the Internet, e.g. from web sites such as Curriki.org and CK-12.org. Information delivered through video, audio and e-books is available to supplement or replace traditional textbooks and to enhance the learning process.

Mobile devices, including Apple's iPad®, are ubiquitous today, used by businesspeople, teachers and students alike. As a result, an industry has developed around these devices for creating mobile applications to enhance their functionality. Mobile applications consist of software that runs on the device and performs certain tasks such as displaying electronic books. The mobile applications may be downloaded either through a hard-wire connection or over a wireless Internet connection. In addition, tablets and notebook devices have significant storage capabilities, are portable and flexible.

### SUMMARY OF THE INVENTION

The present invention was conceived to improve the delivery of multimedia educational content to the classroom or other learning centers by marrying the availability of digital and multimedia educational materials and the capabilities of various mobile devices, including the Apple iPad®.

Furthermore, another object of the present invention is to untether students from books and desktop computers by providing an Internet-based resource for creating and storing customized educational courses and delivering that content to a mobile device such as a tablet computer.

In order to achieve the above objects, the present invention provides a mobile learning system having a remote server (and storage) and a mobile device capable of communicating with the remote server over the wireless Internet. The system comprises at least one software program associated with the server for aggregating and organizing digital educational content and an application associated with the mobile device for retrieving from the server the aggregated and organized digital content. The web-based application further presents the educational content in a format useable by the mobile application.

### BRIEF DESCRIPTION OF THE DRAWINGS

A full understanding of the invention can be gained from the following description of the preferred embodiments when read in conjunction with the accompanying drawings in which:

FIG. 1 is a block diagram showing a mobile learning system according to an embodiment of the present invention;

FIG. 2 shows an exemplary website interface to create an item according to an embodiment of the present invention;

FIG. 3 shows an exemplary website interface to search for items according to an embodiment of the present invention;

FIGS. 4A, 4B and 4C show an exemplary website interface to create a unit according to an embodiment of the present invention;

FIG. 5 shows an exemplary website interface to search for units according to an embodiment of the present invention;

FIGS. 6A, 6B and 6C show an exemplary website interface to create a course according to an embodiment of the present invention;

FIG. 7 shows an exemplary website interface to organize and display website users' content.

FIG. 8 shows an exemplary mobile device interface to search for downloadable content according to an embodiment of the present invention; and

FIG. 9 shows an exemplary mobile device interlace to display downloaded content according to an embodiment of the present invention.

### DETAILED DESCRIPTION OF THE INVENTION

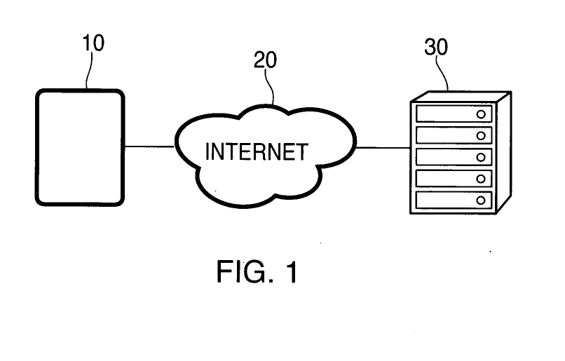

FIG. 1 illustrates a mobile learning system in accordance with a preferred embodiment of the present invention. In this figure, the system comprises a mobile device 10 and a remote server 30, which communicate over the Internet 20 according to an embodiment of the present invention.

According to a preferred embodiment of the present invention, the remote server 30 hosts a website, which is built using a Relational Database Management System using the Microsoft .NET architecture. The database is created with Microsoft SQL, and all web services on the site are coded in Visual Basic. Preferably, all assets within the website are modified using this technology.

The website is navigated using a series of interfaces and screens that prompt a website user, i.e., an educator, to upload and store content from other websites or from other storage locations, such as the user's own computer. Content includes video, images, text, audio, slideshows, etc. Upon entering the website, the user will be asked to create an account or other identifying record associated with that website user.

Content on the website may be aggregated in various ways. In a preferred embodiment, data may be organized as items, units or courses. Individual data, including text, video or audio, may be stored as items. The website user may then organize those items into a unit or multiple units. Alternatively, the website user may first create a unit and then populate the unit with one or more items. In turn, units or items may be combined to create a course. Alternatively, the website user may create a course by type and subject, without at that time including any units or items. After the course is created the user may populate it with items from other courses or units, or with newly created items. In a preferred embodiment, courses, units and items, exist independently on the website, which permits users of the website to independently access and use either entire courses, units or individual items. This also permits the user to move items between units and courses and to reuse content in other units and other courses.

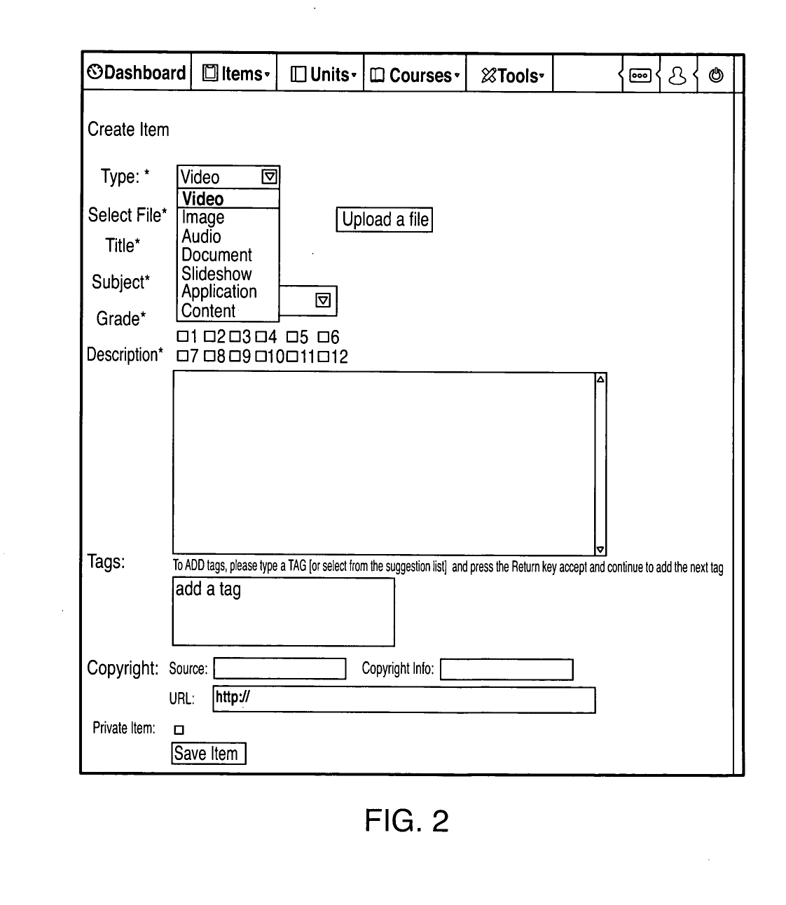

FIG. 2 shows a website user interface for creating an item. As shown in the figure, a user is presented with pull-down menus for creating an item. In a preferred embodiment, the user creates an item by selecting a content type from a pull-down menu. For example, the user may choose from any of the following file types: video, image, audio, document, slideshow, application or content. Other file types may also be available or, alternatively, the user may be given the option of typing in a particular file type. After selecting the file type for the content, the user is prompted to upload the educational content for this item. To help identify the content later, the user may identify the content by subject, e.g., history, math or science, and by grade level, e.g., 8th grade or 9th grade. A particular item may be applicable to more than one grade level. The user also provides a description of the content or associates a tag with the content. For example, if the content for this item is a video segment on a particular historical event, the user may identify that video with a description of the event, including the date of the event and any of the key characters associated with the event.

As further shown in FIG. 2, the website user is prompted to enter copyright or licensing information, as necessary. Also, the user has the option of designating the item as private, which makes it unavailable to other users of the website, without the consent or permission of the item creator or without entry of a password. By designating an item, unit or course as private, only a mobile device user who enters the correct password can gain access to the protected, item, unit or course. In a final step, the item is saved.

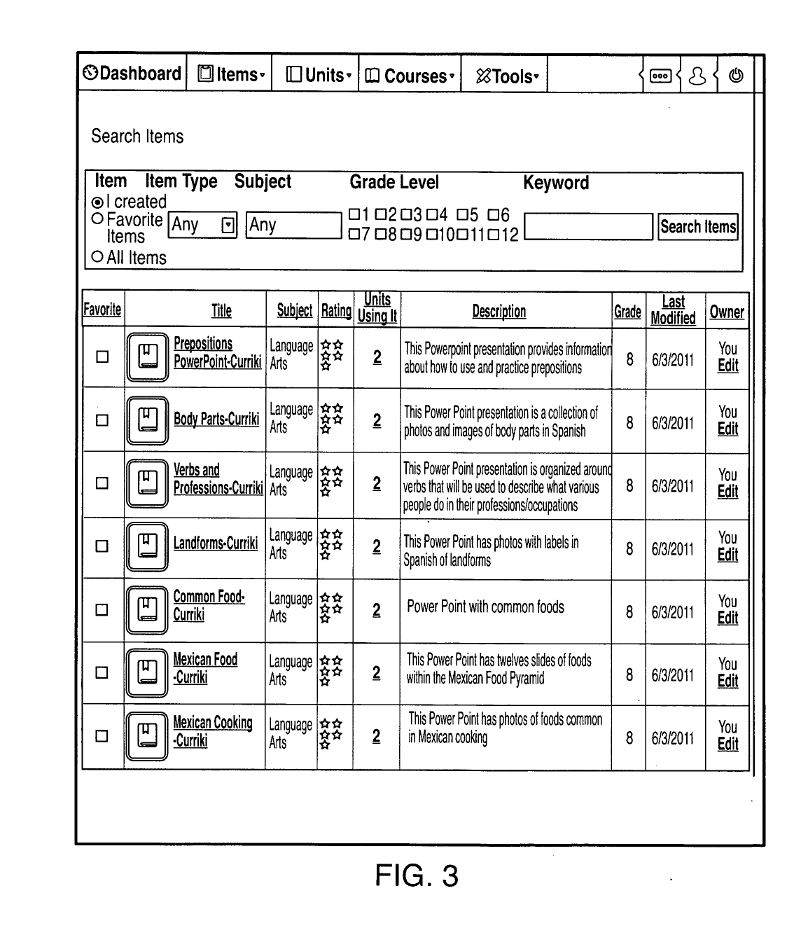

FIG. 3 shows an exemplary website interface for searching previously created and saved items. As shown in FIG. 3, the user can search for an item by category, such as by subject or grade level. A user conducting such a search will return all items associated with the website, not marked private, which are related to a particular subject or grade level. As previously mentioned, by permitting users to separately save and store individual items, other users may pick and choose individual items to share or create their own courses or units from those items.

As further shown in FIG. 3, the website permits the user to search for items based on key words associated with the item or based on the type of item, e.g., audio, video or text. Also, users are given the option to save any items turned up in a search to a list of favorites, which the user can later access to populate a course or unit.

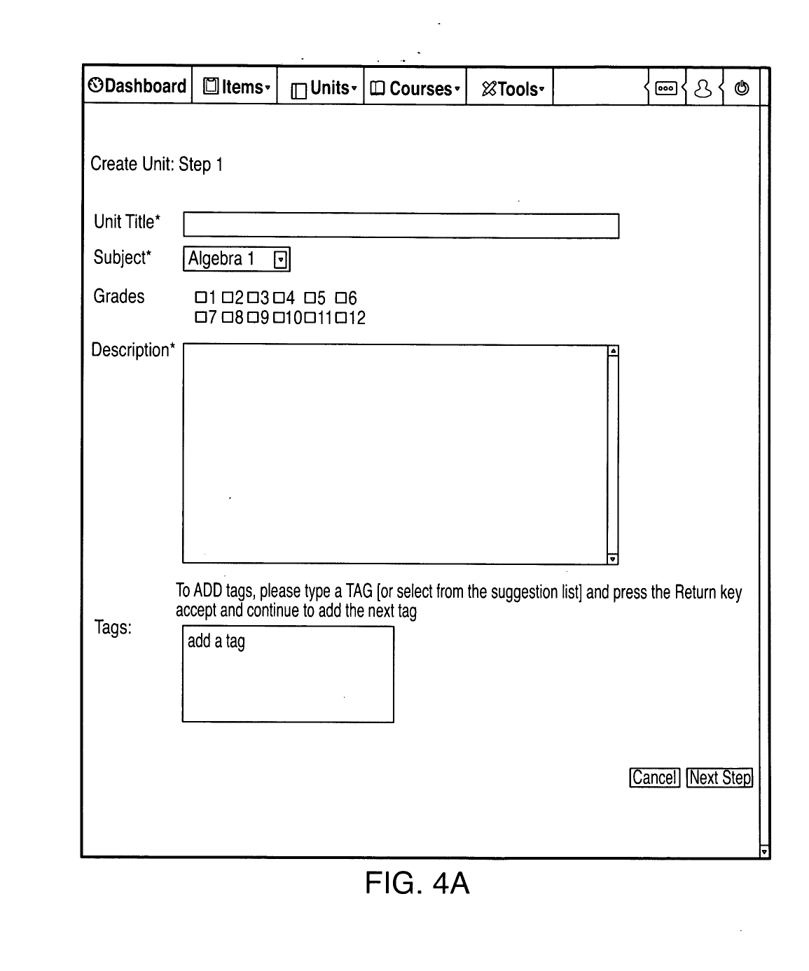

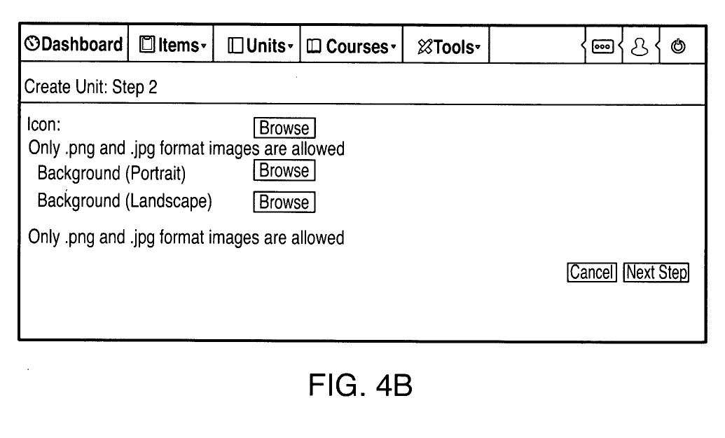

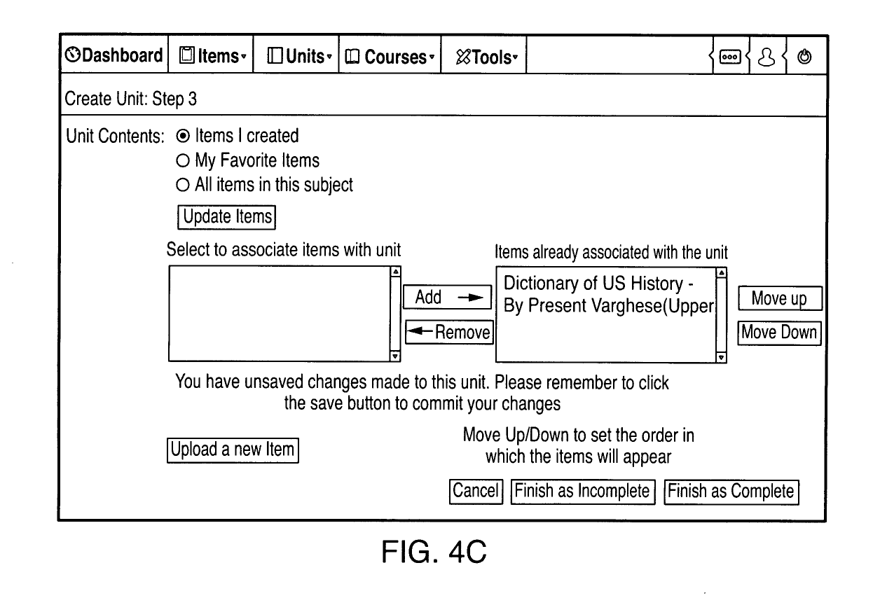

In a preferred embodiment, the website user may also create a unit, which is essentially an electronic folder for holding individual items. As shown in FIG. 4A, like an item, a unit is identified with a subject and a grade level. The website also prompts the user to provide a description and tag for that unit. Referring to FIG. 4B, after creating a unit, the website prompts the user to associate an icon with the unit.

As shown in FIG. 4C, a unit may be populated with any of the following: items created by the user, items in the user's list of favorites or items identified by a particular subject or other search criteria.

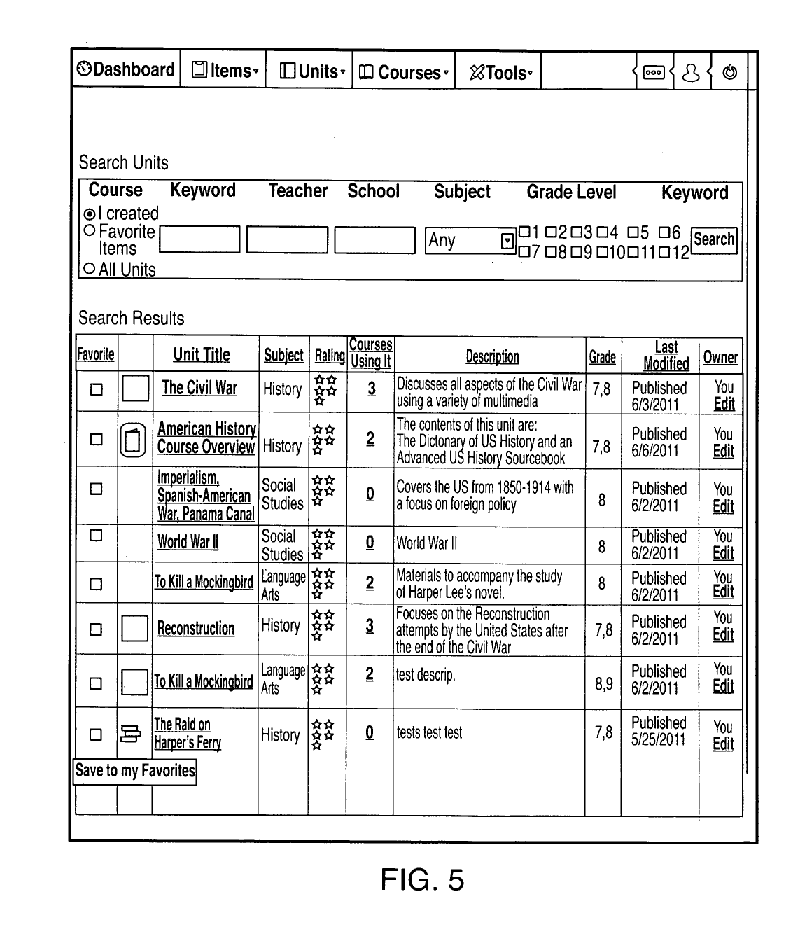

A user may search for units by keyword, teacher, school, subject, grade level or other indicia that may be associated with the units by either the system or the creator of the unit. As with items, a website user may save a unit to his or her list of favorites. FIG. 5 is an exemplary website interface to search for saved units.

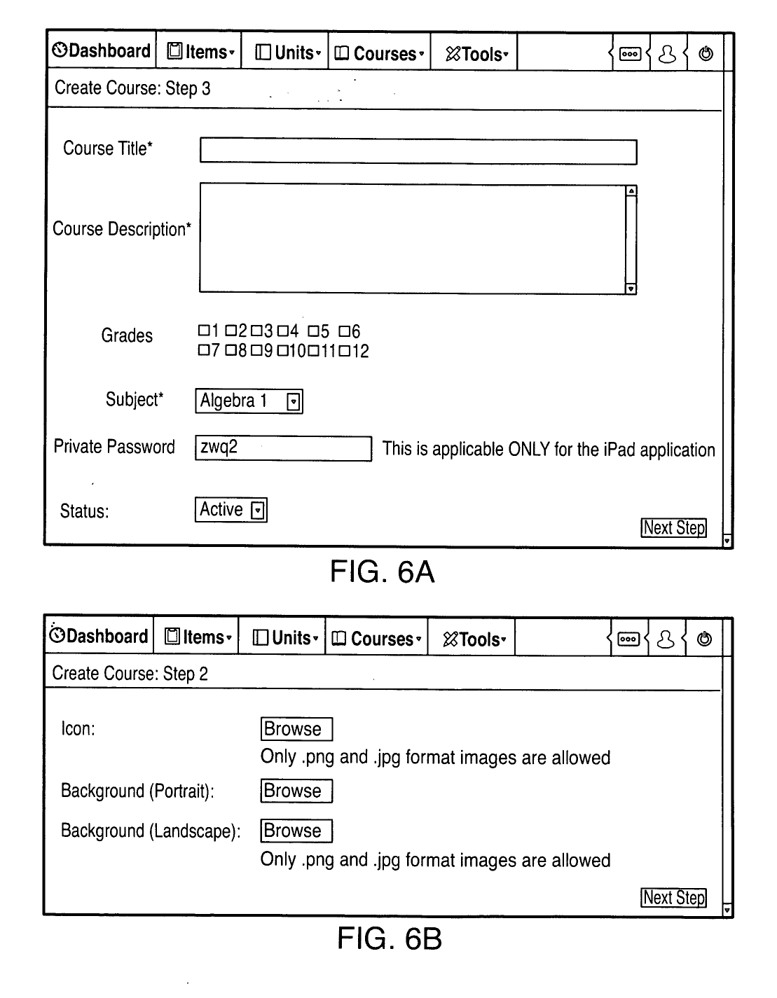

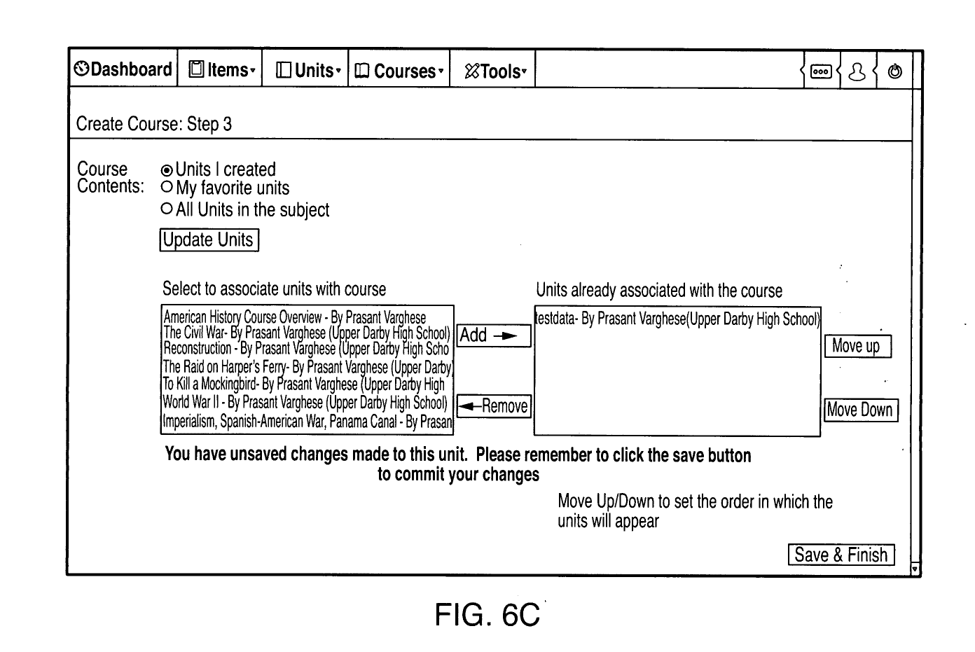

In a preferred embodiment, the user may also create a course, which is an electronic folder for holding units. As shown in FIGS. 6A and 6B, the user selects the option to create a course and can enter a title, description, subject and grade level for the course, and designates the course with an icon. Other descriptors and keywords may be associated with the course for later reference. The user may then select units or items to populate the course with content, as shown if FIG. 6C. Again, the content includes video, images, text, audio, slideshows, weblinks and external applications.

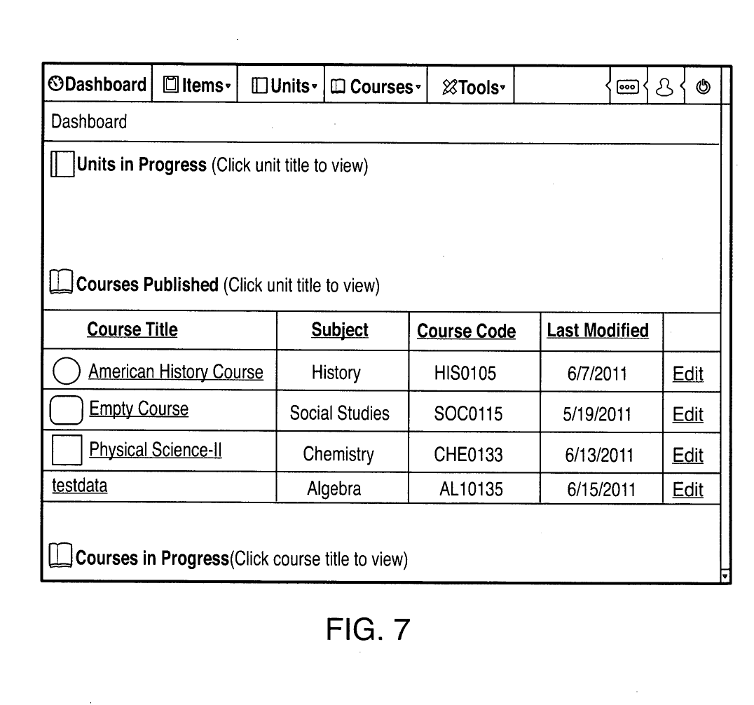

The website is also provided with an interface, a dashboard, for organizing and displaying a website a particular user's content. As shown in FIG. 7, the dashboard may be used to display a users units in progress, courses in progress and published courses. The website user may launch any of the foregoing from this page.

In a preferred embodiment, the website also permits other website users to rate anther website user's content, either items, units or courses. As shown in FIG. 5, for example, each of the retrieved units is assigned a rating, which provides the website user another metric for selecting a particular unit.

The website may include features for policing content that is uploaded to the website. For example, the website may include software for screening content from third party websites or may prohibit users from uploading data from certain websites or permit data to be uploaded only from certain authorized websites. Those restrictions may apply to all users or may be applied. to specific users.

As shown in FIG. 1, the mobile device 10 and the remote server 30 communicate over the Internet 20. In a preferred embodiment the mobile device accesses the Internet over a wireless network such as WiFi, WiMax or Bluetooth, including all 802.11 variants. However, other communication networks are also possible, including cellular and local area networks. It is anticipated that such a wireless network would be available in, for example, a school's classroom.

In a preferred embodiment, the application is adapted for use on a mobile device 10, such as Apple's iPad®. Accordingly, the applications may be coded using Objective C, using Apple's Development Environment, Xcode. The application communicates with the website's services using, for example, a mobile web browser, to pull queried material from the site, onto the iPad. The communication techniques are well known in the industry. Applications may also be configured for use with other mobile devices running, for example, the Android® operating systems or other similar operating systems.

In a first step, a student uses the mobile device 10, e.g., the Apple iPad®, to download the mobile application to his or her mobile device 10. The mobile device user, e.g., the student, launches the mobile application, which communicates with the remote server over a wireless Internet connection. First time users may be asked to register with the website. Upon registration, if required, the mobile device user is authorized to access certain course, units or items specifically created for that user. The mobile device user may also be authorized to access certain publicly available courses, units or items.

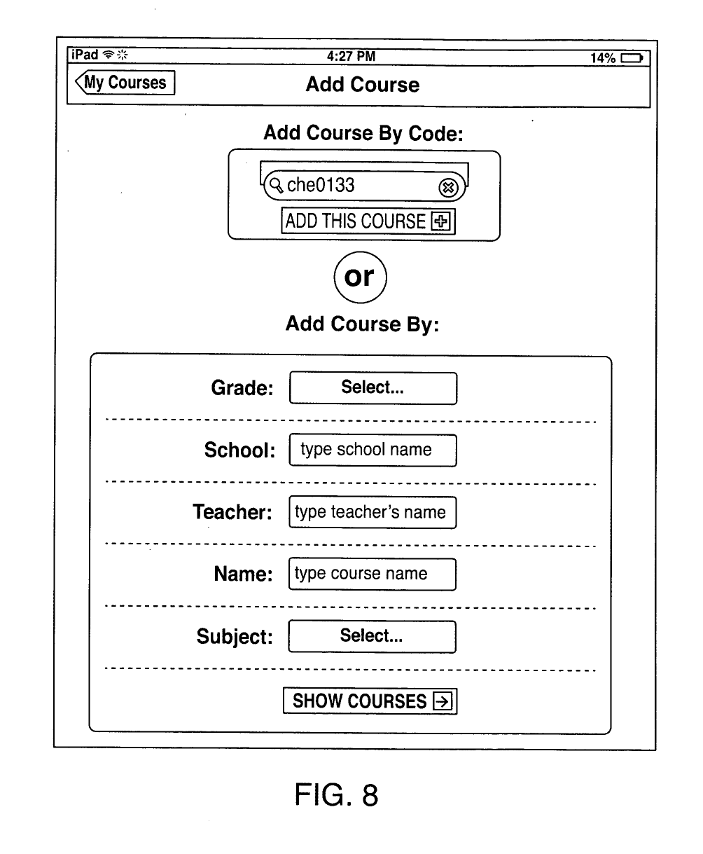

As shown in FIG. 8, the mobile device user is presented with a search screen that allows the user to search for a course by a unique identifier, which is created by the website to allow the mobile device user to easily identify the downloadable content. Alternatively, the mobile device user can search for courses by grade level, school, teacher, name or subject. In addition, the mobile device user may request the website to list all available courses for download. The user may then download all or part of an available course to his or her mobile device. Each downloaded course is preferably designated by an icon and other highly detailed information describing the course.

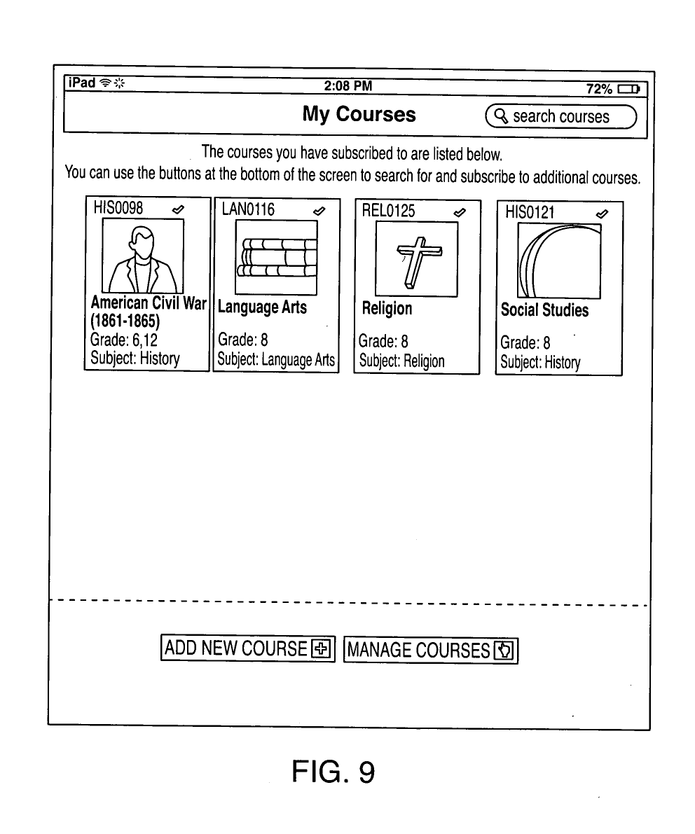

As shown in FIG. 9, after download, the course icons are presented in a central hub (My Courses page). From the My Courses page, the mobile device user can select a course and display the units associated with the course. The mobile device user may then select a particular unit to display the items associated with the unit. The user can then select and launch a particular item. The item may be a PDF, ebook, video, audio, slideshow, weblink or external application. Certain content may be restricted and require the user to enter a password to access that material.

In a preferred embodiment, the mobile application permits the playing of .mp4 video files uploaded to the website, .mp3 audio files uploaded to the website, and .jpeg, .png, and .gif files uploaded to the website. In the case of text, in a preferred embodiment, the mobile application will support PDFs (for example, all MS Office documents would be saved as PDFs on the website to be uploaded and read on the mobile application). Other data formats such as PowerPoint can be saved as a set of images to upload as a slideshow. However, other application types may also be permitted without deviating from the object of the present invention (for example, the application may be adapted to read MS office documents directly). In addition, third party mobile applications may be used to display other data formats on the user's mobile device.

The downloaded course may also include external applications and weblinks. In the case of an external application, the mobile application will only launch out to external applications already on the mobile device that have been specified on the website by specific URL schemes. Weblinks are preferably launched in a web browser adapted to operate within the mobile application, e.g., Apple's Safari browser.

In another embodiment, the mobile application may be used to support interactive quizzes, games, and assessments that a teacher can upload to the site, which can then be completed by students and electronically sent back to the teacher for further analysis. The mobile application may also be used to display a student's customized course schedule, to take notes, to record a journal, to annotate educational materials, or to exchange messages, annotations, assignments, test results or other documents with a teacher or other students.

To limit compatibility issues, the website controls the type of files that may be uploaded by the website user, e.g., the educator. If the website user is able to get around this first checkpoint, then the content will be uploaded to the site. If that content is downloaded onto the mobile device, then the designated reader will refuse to play the file, forcing the mobile device user go back out to view another item.

In the preferred embodiment, the mobile application permits the mobile user to sync downloaded courses with an updated or changed version of the course available on the website. The mobile device user m ay receive a notice of updated content from the remote server 30. Alternatively, the mobile application may periodically synchronize the mobile device 10 with the remote server 30 to search for and download any updated content. The mobile device user may also delete any downloaded content or portions thereof from the mobile device. In addition, the mobile device user may be permitted to rate a particular course, unit or item through functionality in the mobile application or through an assigned mobile device user interface on the website. Feedback from the mobile device user on the content can be made immediately available to the content creator, e.g., the teacher, who can then modify a particular course, unit or item on the website. The ability to quickly modify a course is an advantage unavailable in a traditional text book-based teaching environment.

In a preferred embodiment, the website users are teachers associated with a particular school or school district. Those teachers will register with the website and either use previously created content or create new content (i.e., items, units and courses), which will be made available for download. The mobile device users are the students in that school or school district, although the content may also made available to students in any school district. Those students will download the mobile application either from the website or a third party site. After downloading the mobile application, the students will be given access to those items, units or courses designated for download by their teachers. In this manner, students and teachers are enabled to conduct an entire class or series of classes using only a mobile device such as the Apple iPad®.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A mobile learning system having a remote server and a mobile device capable of communicating with the remote server, the system comprising: at least one software program associated with the server for aggregating and organizing digital educational content and an application associated with the mobile device for retrieving from the server the aggregated and organized digital content, the application further presenting the educational content in a format useable by the mobile device.

2. The mobile learning system of claim 1 wherein the mobile device is a tablet, laptop, or other mobile computer.

3. The mobile learning system of claim 1 wherein the remote server stores content as at least one of an item, a unit and a course.

4. The mobile learning system of claim 3 wherein the course consists of one or more units.

5. The mobile learning system of claim 1 wherein the mobile device application synchronizes the mobile device with the remote server to search for and download updated digital content.

6. A method for aggregating, organizing and presenting digital educational content to a group of users comprising the steps of: providing an application associated with a remote server including at least one user interface for retrieving and storing digital education content on the remote server; permitting a user to aggregate and organize the educational content; providing a mobile device user with a mobile application for downloading the digital education content to the mobile device; launching the mobile application to download the digital education content for display on the mobile device; and periodically synchronizing downloaded digital education content with updated digital education content on the remote server.

7. The method of claim 6 wherein the digital education content is uploaded and saved on the remote server as items.

8. The method of claim 6 wherein the digital education content is saved on the remote server as a unit.

9. The method of claim 8 wherein at least one unit is used to create a course.

10. The method of claim 6 wherein the digital education content is uploaded and saved on the remote server as at least one of items, units and courses.

11. The method of claim 10 wherein a user of the application associated with remote server may search digital education content saved as one of items, units and courses.

12. The method of claim 6 wherein the mobile device downloads the digital education content over a wireless network.

13. The method of claim 6 wherein the digital education content is retrieved from at least one of the Internet and storage devices associated with a user of the remote server.

14. A mobile device for communicating with a remote server having preformatted educational content, the mobile device comprising: a screen display and at least one of soft keys and hard keys; an operating system for controlling user interaction; wireless communication service, and a software application for wirelessly downloading to the mobile device the preformatted educational content, the software further permitting the user to view the downloaded preformatted educational content.

15. The mobile device of claim 14 wherein the mobile device is a tablet, laptop, or other mobile computer.

16. The mobile device of claim 14 wherein the mobile device software application displays the preformatted educational content as at least one of an item, a unit and a course.

17. The mobile device of claim 16 wherein the course consists of one or more units.

18. The mobile device of claim 14 wherein the software application functions to synch the mobile device with the remote server to search for and download updated preformatted educational content.
